(19) United States
(12) Patent Application Publication
(10) Pub. No.: US 2026/0141211 A1
(43) Pub. Date: May 21, 2026

(54) GENERATION OF NEURAL NETWORK WEIGHTS USING A DIFFUSION PROCESS

(71) Applicant: GDM Holding LLC, Mountain View, CA (US)

(72) Inventors: Florian Nils Hartmann, Zürich (CH); Duc-Hieu Tran, Zürich (CH)

(21) Appl. No.: 19/367,439

(22) Filed: Oct. 23, 2025

Related U.S. Application Data
(60) Provisional application No. 63/710,648, filed on Oct. 23, 2024.

(51) Int. Cl. G06N 3/04; G06F 40/284

(52) U.S. Cl. CPC G06N 3/04; G06F 40/284

(57) ABSTRACT

Systems, methods, and computer programs for determining values of weights to fine-tune a target neural network. In implementations the values of the weights are determined using a language model neural network in combination with a diffusion model neural network system, based on high-level user instructions. The target neural network fine-tuned with the determined values of weights can then be used to perform a particular processing task.

### CROSS-REFERENCE TO RELATED APPLICATION

This application claims priority under 35 U.S.C. 119 to Provisional Application No. 63/710,648, filed Oct. 23, 2024, which is incorporated by reference.

### BACKGROUND

This specification relates to processing data using machine learning models.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes systems and methods, implemented as computer programs on one or more computers in one or more locations, for determining values of weights, and optionally other parameters, of a target neural network. The target neural network with the determined values of weights can then be used to perform a processing task. The described techniques use a language model neural network to generate values of the weights based on high-level user instructions.

According to one aspect there is provided a method, implemented by one or more computers for determining values of weights for a target neural network. The method involves receiving task description text that defines a processing task that the target neural network should perform, and tokenizing the task description text to obtain a prompt sequence of tokens that defines the processing task. The prompt sequence of tokens is processed using a language model neural network to generate task encoding data that encodes the processing task.

Implementations of the method generate a set of weights for the target neural network by initialising a frame of data comprising data elements representing an initial set of weights for the target neural network, and generating a frame of data representing a final set of weights for the target neural network for performing the processing task by iteratively refining the frame of data. The iterative refining involves, at each of a succession of weight generation time steps, processing the frame of data for the weight generation time step using a denoising neural network system conditioned on the task encoding data, to refine the frame of data for a next weight generation time step. This continues until a final iteration, at which the frame of data represents the final set of weights for the target neural network. Values of weights for the target neural network are determined from the frame of data at the final iteration.

In another aspect there is described a method of training a denoising neural network system for determining values of weights for a target neural network. The method involves implementing an example of the target neural network, and training the example of the target neural network, saving checkpoints of the target neural network during the training. A checkpoint comprises values of a set of weights of the target neural network. The denoising neural network system is trained using the saved checkpoints.

In another aspect there is described a method of performing a processing task using a target neural network. The method involves obtaining a target neural network input for the target neural network, and processing the input using the target neural network and in accordance with values of the weights of the target neural network determined as described herein, to generate a target neural network neural network output that performs the processing task.

There is also described a system comprising one or more computers, and one or more storage devices communicatively coupled to the one or more computers. The storage devices store instructions that, when executed by the one or more computers, cause the one or more computers to perform the operations of the described methods.

There are further described one or more non-transitory computer storage media storing instructions that when executed by one or more computers perform the operations of the described methods.

The subject matter described in this specification can be implemented in particular embodiments so as to realize one or more of the following advantages.

Unlike some other techniques that require a complete training dataset to determine a set of weights for a model represented by a target neural network, implementations of the described techniques use a high-level task description, e.g. in natural language text, to fine-tune a model for a particular processing task. This can make it much quicker and easier for a user to obtain a model that is adapted to a particular task.

By removing the need to obtain and process a large training dataset, memory and compute requirements are also significantly reduced. For example, in implementations weights are obtained by an inference process that avoids the need to store a large training dataset. The described techniques can also be much faster and more computationally efficient than conventional approaches to weight determination based on backpropagating gradients of a training objective function. For example, a conventional approach might also need to store gradients and optimizer states, which are not needed in implementations of the described techniques. Implementations of the techniques can reduce the memory needed, compared with conventional fine-tuning, by up to a factor of two.

Similarly fine-tuning, and in particular hyperparameter tuning, can be complex and involve some trial-and-error, and backpropagating gradients is a computationally expensive and time-consuming process. Implementations of the described techniques can eliminate the need to tune parameters such as learning rates, batch size, optimizer choice, and so forth.

A user can obtain a trained neural network from a description of a processing task to be performed and, optionally, a small number of examples. It is not necessary for the user to have a high level of machine learning expertise. In some implementations the user can choose an architecture of the target neural network; in some implementations the system can choose the architecture for the user. Some implementations of the techniques enable a user to specify a multimodal data processing task to be performed by the target neural network, i.e. the task description can include images, audio and videos.

The described techniques can be used to determine very large numbers of weights, e.g. greater than 10⁵, 10⁷, ∨10⁹ weights, of a similar order to the number of pixels in a still or moving image. As an example, the described techniques can be used to determine weights for at least part of an LLM (large language model) or VLM (vision language model). They can also generalize to new target neural network architectures, different to those seen during training.

Some implementations of the described techniques can guide the weight diffusion process in a manner that improves convergence to useful weight values. Implementations of the techniques can determine which weights to update and/or whether or not to use an adapter neural network.

Some implementations of the described techniques are adapted to efficient implementation on distributed and/or parallel processing computing systems, e.g. for efficiently providing sets of weights to large numbers of different users.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example system for determining values of weights for a target neural network.

FIG. 2 is a flow diagram of an example process for determining values of weights for a target neural network.

FIG. 3 shows an example of the system adapted for implementation in a parallel processing environment.

FIG. 4 is a flow diagram of an example process for training the system.

FIG. 5 is a flow diagram of an example process for performing a processing task using a target neural network trained by the system.

Like reference numbers and designations in the various drawings indicate like elements.

### DETAILED DESCRIPTION

Some implementations of the described techniques are based on the insight that neural network weights have a similar form to images. For example, fully-connected layers have the same shape as 2D images, and convolutional layers have a shape similar to “3D” images where here a “3D” image refers to a 2D image with RGB channels.

In more detail, the weights of a fully-connected layer can be reshaped into a 2D matrix that can be conceptualized as an image where each element in the matrix (pixel in the image) represents a connection strength between neurons in the preceding and succeeding layers. For example if a layer has N input neurons and M output neurons a weight (i,j) in a weight matrix of size N×M corresponds to the weight of the connection between the i-th neuron of the input layer and the j-th neuron of the output layer.

In a convolutional neural network (CNN) layer a single kernel, or filter, structure has spatial dimensions of height and width and a third dimension corresponding to the number of input channels to the kernel, i.e. it is a tensor of rank 3. For an RGB image the kernel would have three dimensions (x,y,3). Here the particular number of color channels, 3, implies a kernel depth of 3 (rather than referring to the three dimensions), but following the analogy, additional color channels could be used, i.e. the kernel is not limited to a depth of 3. The CNN kernel is analogous to a small color image; the full image can define all the kernels for a layer (which determines the kernel output channel dimension).

Multiple neural network layers can be considered as analogous to multiple frames in a sequence of video frames. In a neural network the layer weights are a form of a manifold transformation function, i.e. the neural network weights define a transformation that maps the input from its original manifold to a new manifold. It has been recognized that these transformations are analogous to the semantic scene transformations in successive frames of a video.

This in turn motivates the use of a diffusion model to generate weights for a target neural network. That is, a diffusion model can be trained to create the manifold transformations that are implemented by the neural network weights. Diffusion models can generate values for large numbers of pixels in an image or video, and hence can also generate a large number of neural network weights. The diffusion model output, comprising the weights, can be packaged into a model file for the target neural network.

Model fine-tuning can be used to improve the performance of a model, i.e. the target neural network, on a new dataset. This starts from an already useful model instead of training the neural network from scratch, but model fine-tuning can be a difficult, computationally expensive, and time-consuming process. Implementations of the described techniques take advantage of large language models, which internally encode world knowledge, to enable model fine-tuning from a high level problem description.

More particularly a text or multimodal prompt, e.g. comprising a description of the task and optionally a few examples (e.g. a small set of sample labeled data of the sample input and the expected results), is processed by a language model. The language model generates an intermediate representation of the task, i.e. task encoding data. The task encoding data is used, in turn, to condition the diffusion model to generate weights for the target neural network, e.g. weights for a sequence of one or more layers of the target neural network, in a similar way to generating a sequence of video frames.

The system is trained using a diffusion model loss, e.g. from checkpoints of a particular target neural network as it is fine-tuned for various example tasks as described to the language model neural network. One or more metrics from training the target neural network (from the checkpoints) can also be incorporated, e.g. a training loss, or accuracy, of the target neural network. The system can have an auxiliary objective of minimizing the loss of the target neural network(s) for the tasks (on the given input sample data, i.e. training data, for the tasks). In implementations the system is trained end-to-end. For example, a language model loss can also be used to help the system to learn the intermediate representation of the task (i.e. the task encoding data) as well as the inner structure and dependencies of the target model weights.

The system can be trained to provide weights for a single target neural network or for a set of different target neural networks, e.g. according to a supported list. In implementations the system can learn the distribution of weights for a relatively diverse range of models, so that it can generalize to new architectures.

Fine-tuning a model, i.e. the target neural network, for a particular task can involve the system generating some of the weights of the model to replace existing, pretrained weights of the model. Also or instead it can involve generating additional weights for one or more additional “adapter” neural network layers, such as a LoRA adapter (Hu et al. arXiv:210609685).

The weights for fine-tuning a model can be generated, e.g., from a random initialization of the diffusion model. The system can also generate the weights for an entire model from scratch, in effect generating a complete model for a specified task rather than fine-tuning a model. In another approach the diffusion model can be initialized from some or all of the pretrained weights, which can then be refined, using a diffusion model guidance process, to adapt, and hence fine-tune, the weights for the specified task.

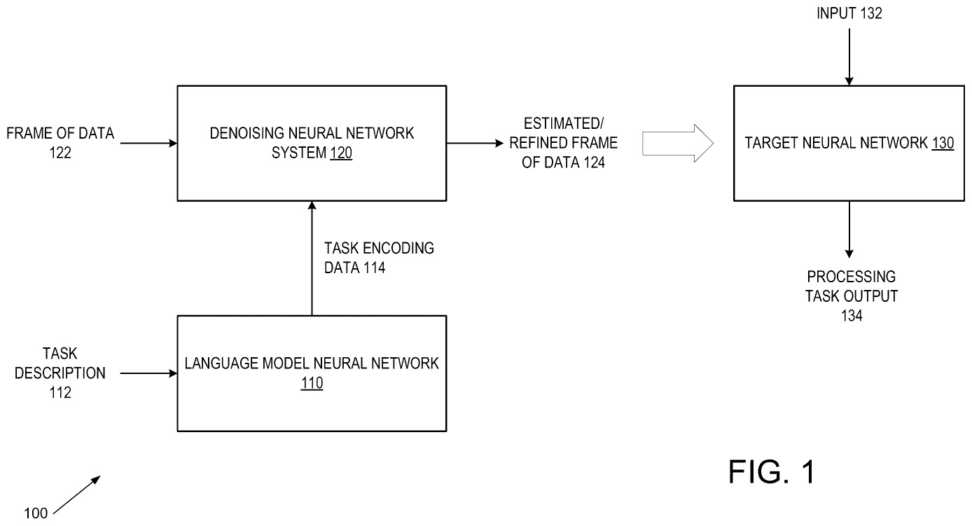

FIG. 1 shows a system 100 for determining values of weights, and optionally other parameters, for a target neural network 130. The system of FIG. 1 can be implemented as computer programs on one or more computers in one or more locations.

The target neural network 130 with the determined values of weights can be used to perform a processing task. More specifically, the target neural network 130 has an input 132 to receive an input data item, and is configured to process the input data item, in accordance with the determined values of the weights, to generate processing task output 134 that comprises an output data item that is a result of the processing task.

The system 100 comprises a language model neural network 110 that is used to generate values of the weights for a target neural network 130 based on high-level user instructions. Implementations of system 100 generate the values of the weights using a reverse diffusion process implemented by a denoising neural network system 120, such as a diffusion model or a consistency model.

The language model neural network 110 is configured to receive and process a task description 112 that defines a processing task that the target neural network should perform, to generate task encoding data 114 that encodes the processing task. The task description generally comprises text; it may also comprise one or more of: images, videos, audio signals, and other types of data.

The task description 112 can optionally include one or more examples of the task; and/or it can specify the target model, e.g. a name of the target neural network 130. In some implementations, e.g. where the system 100 also optimizes the target neural network architecture, e.g. by selecting from a supported list of models, the task description 112 can specify one or more desired metrics for the target neural network 130. As a further example, the task description 112 can include an optional maximum number of parameters to fine-tune. This can be used, e.g., to decide whether the full model weights should be trained, or if only a small adapter, such as a LoRA adapter, should be generated.

In implementations, although not necessarily, the task description 112 is processed (“tokenized”) to obtain a sequence of tokens that defines the processing task. The sequence of tokens can be referred to as a prompt sequence of tokens. In implementations the prompt sequence of tokens is processed using the (trained) language model neural network 110 to generate the task encoding data 114 that encodes the processing task. It can be useful if the language model neural network 110 can process a prompt sequence of, e.g., greater than 1 million tokens.

In general, the language model neural network 110 is a sequence processing neural network. It can be configured to process an input sequence of tokens to generate an output sequence of tokens. It can be, but need not be, configured as an auto-regressive neural network.

In implementations, the language model neural network 110 is a neural network that has been pre-trained so that, given a text prompt that includes a sequence of tokens in a natural or computer language, the language model neural network can generate the next token in the sequence. This process can be repeated to extend the text prompt one token at a time to generate a natural or computer language output, i.e., to generate the output auto-regressively token by token. The input tokens and output tokens can be as described later.

At each time “time step” the language model neural network 110 can process a current sequence of tokens to generate a probability distribution over a vocabulary of tokens. The next token for the sequence can then be selected using the probability distribution, e.g., by sampling from the distribution using nucleus sampling or another sampling technique or by selecting the highest-probability token. In general, the language model neural network 110 has been trained on a corpus of text made up of tokens from the vocabulary (and optionally other tokens that can be mapped to a designated out-of-vocabulary token), to predict the next token in a sequence of tokens from the training data.

In general a (trained) language model neural network can be made to perform a particular task by providing a natural language description of the desired response as an input or “prompt”. In some cases, the prompt may be a few-shot prompt where a few, e.g., 1 to 10, examples of an example task input and an example task output are provided in the text e.g. prior to the actual task description.

Optionally, but not necessarily, the language model neural network 110 can be further trained, i.e. “fine-tuned”, specifically for use in determining values of weights for the target neural network 130. This can be done by obtaining a pre-trained language model neural network that has been trained on a large corpus of examples as previously described, and then further training part of all of the language model neural network on a relatively small number of examples particular to determining values of weights for a target neural network. This is described further later.

The language model neural network can be a large language model neural network, e.g., one that has greater than 1 billion, 10 billion or 100 billion trained parameters. The language model neural network can have been trained on greater than 10 billion, 100 billion or 1000 billion words or tokens representing words or other text tokens, e.g., sub-words (also known as “word pieces”).

In some implementations, the language model neural network 110 is an autoregressive transformer neural network; it can be, e.g. an encoder-decoder model (such as T5, Raffel et al., arXiv:1910.10683), or a decoder-only model (such as PaLM arXiv:2204.02311, or Chinchilla arXiv:2203.15556). A transformer neural network can be characterized by having a succession of self-attention neural network layers. A self-attention neural network layer has an attention layer input for each element of the input and is configured to apply an attention mechanism over the attention layer input to generate an attention layer output for each element of the input; there are many different attention mechanisms that may be used. In some implementations the language model neural network 110 can be a mixture-of-experts model.

In some implementations the language model neural network 110 is a VLM (vision language model) or a multimodal language model, i.e. the language model neural network 110 can process multimodal input tokens and/or generate multimodal output tokens (such as Gemini, arXiv:2312.11805). A multimodal token can be one that can represent multiple data modes such as text and/or image and/or audio.

Merely as a particular example, the language model neural network 110 can auto-regressively generate an output sequence of tokens by generating each particular token in the output sequence conditioned on a current input sequence that includes any (e.g. all) tokens that precede the particular token in the output sequence, i.e., tokens that have already been generated for any previous positions in the output sequence that precede the particular position of the particular token, and the input sequence. That is the current input sequence when generating a token at any given position in the output sequence can include the input sequence and the tokens at any preceding positions that precede the given position in the output sequence.

For example, to generate a particular token at a particular position within an output sequence, the language model neural network can process the current input sequence to generate a score distribution that assigns a respective score, e.g., probability, to each token in a vocabulary of tokens, and can then select, as the particular token, a token from the vocabulary using the score distribution. Such a language model neural network can, e.g., have any of a variety of Transformer-based language model neural network architectures. Examples are described in arXiv:2305.10403 (2023); and Gemini Team papers arXiv:2312.11805 (2023); arXiv:2403.05530 (2024), and arXiv:2507.06261 (2025). In a language model neural network with a Transformer-based architecture an output subnetwork can process an output hidden state for the last input token in the input sequence, generated by the last attention block in the succession of self-attention neural network layers, to generate the score distribution. In some implementations the task encoding data 114 may comprise soft tokens, e.g. the task encoding data 114 may comprise features of the output hidden state generated by the last attention block.

A “token” as used in this specification is a vector of numerical values having a specified dimensionality. Text, image, audio, and multimodal tokens (where present) can have the same dimensionality.

In some implementations the tokens can represent text, e.g., words, wordpieces or characters, in a natural or computer language. For example text of the task description may be received, e.g., as a series of encoded characters, e.g. UTF-8 encoded characters; such “characters” can include Chinese and other similar characters, as well as logograms, syllabograms and the like. A text encoder, i.e. a tokenizer, can process a sequence of text to represent the text as a series of text tokens from a vocabulary of text tokens, e.g. that each represent words, wordpieces or characters in a natural or computer language. The computer language may be any formal language used to communicate with a computer, e.g. a markup language, or a command or configuration language, or a data exchange language such as JSON, or a programming language. The tokenizer can, e.g., implement BPE (Byte Pair Encoding), or byte-level BPE or Wordpiece tokenization (or the tokenizer may be omitted and, e.g., the language model neural network 110 may process raw, e.g. UTF-8, bytes). Optionally the task description can be obtained from audio data representing speech, e.g. using a speech recognition system.

In some implementations, as described further later, some of the tokens may represent an image. For example a set (sequence) of image tokens can represent an image. Each image token may comprise a block encoding of values of the pixels in a different region of an image that maps a set of values of the pixels to a respective image token. The block encoder may comprise a neural network, e.g. having one or more (self-)attention layers, such as a Transformer neural network. As used herein an image may be a still image or a moving image.

In some implementations, as described further later, some of the tokens may represent audio, e.g. an audio waveform. For example a set (sequence) of audio tokens can represent audio data that defines an audio waveform e.g. instantaneous audio amplitude values or time-frequency audio data. Each audio token may comprise a block encoding of the audio waveform in a different time segment of the audio that maps a set of values representing the audio waveform to a respective audio token. The block encoder may comprise a neural network, e.g. having one or more (self-)attention layers, such as a Transformer neural network.

Thus the sequence of tokens may comprise a sequence of multimodal tokens. Then, optionally, audio or an image may be flagged by a start-of-audio token or start-of-image token. As used herein a “modality” refers to a type of data, and a multimodal machine learning model is one that can process multiple different types of data.

Referring next to the denoising neural network system 120, this can implement, e.g., a diffusion model, or a consistency model (e.g. as discussed in Heek at al. arXiv:2403.06807). In general, a diffusion model or a consistency model can generate a frame of data by performing a reverse diffusion process to gradually “de-noise” an initial frame of data over a succession of time steps. In the context of this specification “denoising” can refer to the refinement of a set of neural network weights (or other parameters), either as part of a process of obtaining the set of weights from scratch, or as part of process of refining a set of weights. The frame of data, i.e. set of weights, is obtained at the final denoising step.

In some implementations the diffusion model operates in a latent space representation of the frame of data (neural network weights). Then a final representation of the data item can be decoded to obtain the (final) frame of data, e.g. using a decoder that has been pre-trained with a corresponding encoder in an auto-encoder framework. (During training the encoder neural network can be used to encode target frames of data in the output space to generate target outputs for the diffusion neural network in the latent space, typically of lower dimensionality).

In general the denoising neural network system 120, implements a denoising neural network, and can have any architecture consistent with processing values of data elements of a frame of data as an input to generate a set of corresponding output values for a frame of data. That is the denoising neural network system can have any architecture that allows the neural network to map a representation of the current version of the data item to a denoising output of the same dimensionality (the dimensionality of the final representation of the data item). In particular the denoising neural network system 120 can use a neural network architecture that is suitable for, or known for, image generation or image processing using a diffusion process.

For example the denoising neural network system can have a U-Net architecture or a variant thereof, e.g. a 3D U-Net architecture (for video), or a Transformer architecture or a variant thereof, or a combination of these. In general the denoising neural network system may comprise one or more feedforward, convolutional, attention, normalization, or other neural network layers.

As one example, the neural network(s) may comprise a U-Net with one or more ResNet blocks and one or more self-attention layers. As another example the neural network(s) may comprise a diffusion transformer (DiT), or a variant thereof, or a transformer backbone. As some particular, illustrative examples, it can have a U-ViT architecture as described in Bao, et al., arXiv:2209.12152, 2023; or Appendix B of Hoogeboom et al., arXiv:2301.11093, 2023; or it can comprise a diffusion transformer as described in Peebles and Xie, arXiv:2212.09748.

The denoising neural network system 120 can be conditioned on the task encoding data 114 in any suitable way. As one example the denoising neural network system 120 can incorporate one or more cross-attention layers to attend to the conditioning data, i.e. the task encoding data 114. As another example, the denoising neural network system 120 can the task encoding data 114 can include one or more other types of neural network layers that are conditioned on the task encoding data 114, such as Feature-wise Linear Modulation (FiLM) layers, layers with conditional gated activation functions, and so on. In implementations the denoising neural network system 120 is conditioned on features representing successive tokens of the output sequence of tokens that has been generated by the language model neural network 110.

In some implementations the denoising neural network system 120 can also process, i.e. be conditioned on, data specifying a time, or identifying a weight generation time step, e.g. an embedding of the time or weight generation time step, e.g. a sinusoidal or other embedding.

The denoising neural network system 120 can, when implementing a diffusion model, use any appropriate diffusion sampler to update the frame of data, e.g., the DDPM (Denoising Diffusion Probabilistic Model) sampler, the DDIM (Denoising Diffusion Implicit Model) sampler or another appropriate sampler, to the estimate to generate the updated, refined frame of data. DDPMs are discussed, e.g., in Ho et al. arXiv:2006:11239; DDIMs are discussed, e.g., in Song et al. arXiv:2010.02502. To generate video the temporal axis dimension can be treated as an additional spatial dimension; or a rolling diffusion technique can be used (Ruhe et al., arXiv:2402.09470v1), or another technique can be used. There are many examples of video diffusion models, e.g. Imagen Video (Ho et al., arXiv:2210.02303, 2022) or Phenaki (Villegas et al., arXiv:2210.02399, 2022).

The denoising neural network system 120 can process a current version of a frame of data 122 to generate an estimated frame of data 124 that should be subtracted from (or added to) the current frame of data to refine the current version of the frame of data. In some implementations the denoising neural network system 120 can process the current version of the frame of data to generate a refined, e.g. de-noised, version of the frame of data 124. Stochastic samplers, such as DDPM, add a small amount of noise back in at each step.

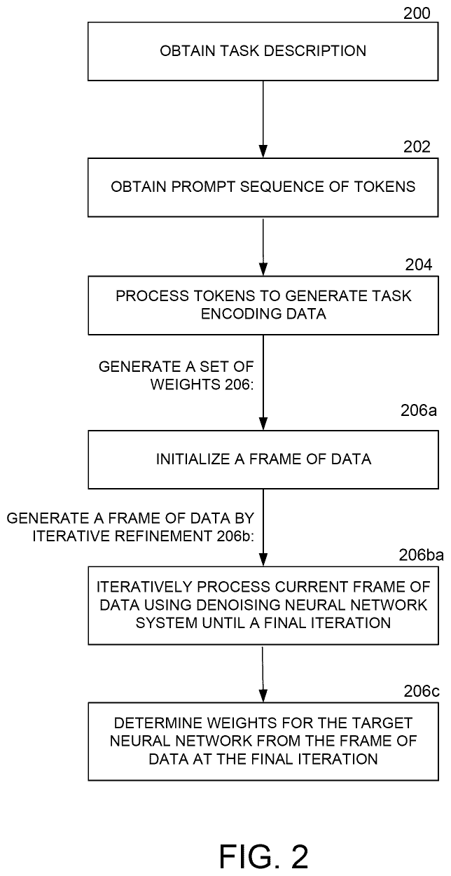

FIG. 2 is a flow diagram of an example process for determining values of weights, and optionally other parameters, for a target neural network. This is also referred to herein as adapting the target neural network. The process of FIG. 2 may be implemented by one or more computers in one or more locations; for convenience the process is described with reference to the system of FIG. 1.

The weights may be determined from scratch, or fine-tuned. In implementations fine-tuning the weights can refer to replacing weights with fine-tuned versions of the weights; or it can refer to adjusting values of the weights to fine tune them. The method can determine values for all the weights of the target neural network 130, or values for just some of weights, or values for weights for one or more adapter neural networks that are applied to the target neural network 130 to modify the behavior (output) of the target neural network, e.g. whilst leaving the weights of the original target neural network 130 unchanged.

The process involves obtaining a task description 112 comprising task description text, e.g. in a natural or computer language, that defines a processing task that the target neural network should perform (step 200). Optionally the task description 112 can also include images, e.g. video; or audio; or other data, e.g. data from one or more sensors.

In some implementations the task description 112 can include one or more examples of the task, e.g. as a few-shot prompt to facilitate in-context learning by the language model neural network 110. Each example of the task can comprise an example input and a corresponding example output that is an example of the processing task having been performed on the example input. In some implementations the task description 112 can include a specification of the target neural network architecture, where there is more than one supported model. In practice the target neural network architecture can be specified by providing a label (name) for the target neural network. The various parts of the task description 112 can be combined into a prompt for the language model neural network 110.

In implementations the task description text is tokenized, e.g. as previously described, to obtain a prompt sequence of tokens that defines the processing task (step 202). The prompt sequence of tokens is processed using the (trained) language model neural network 110 to generate the task encoding data 114 that encodes the processing task (step 204).

In implementations generating the task encoding data 114 involves processing the prompt sequence of tokens using the language model neural network 110 to generate, in turn, features representing successive tokens of an output sequence of tokens. The task encoding data 114 can be obtained from the features of one or more tokens of the output sequence of tokens, e.g. these features can be used as the task encoding data or they can be further processed to obtain the task encoding data 114.

The features representing one or more tokens can be obtained, e.g. from one or more intermediate layers, or from a final layer of the language model neural network 110. As some examples the features may comprise, e.g., features of a final self-attention neural network layer of the token generation neural network, or features of a subsequent linear layer to the final self-attention neural network layer, or features of a subsequent softmax layer (“soft tokens”).

To generate features representing successive tokens of the output sequence of tokens, features for multiple tokens may be combined, e.g. by pooling. As another example, the language model neural network 110 can generate (e.g. it can be trained to generate) a summary token which, if generated autoregressively, comprises features that summarize preceding tokens of the output sequence of tokens. In general, the features from which the task encoding data 114 is obtained may be represent, directly or indirectly, the tokens of the output sequence.

Although the language model neural network 110 is used to generate the task encoding data 114 it need not explicitly generate a text output (though it may do). That is, in implementations the features used to generate the task encoding data 114 can be obtained without decoding these into text.

The system then generates a set of weights for the target neural network (step 206).

In implementations this involves initialising a frame of data comprising data elements that represent an initial set of weights for the target neural network (step 206a).

In some implementations the data elements corresponding to the target neural network weights are randomly initialized. In some implementations the data elements corresponding to the target neural network weights can be initialized to the pre-trained weights to be fine-tuned, in which case a small amount of noise can be added to the pre-trained weights for processing (denoising) by the diffusion model.

The system generates a frame of data, representing a final set of weights for the target neural network for performing the processing task, by iteratively refining (denoising) the frame of data (step 206b).

In general the iterative refining can involve, at each of a succession of weight generation time steps, processing a current version of the frame of data for the weight generation time step using the (trained) denoising neural network system 120 conditioned on the task encoding data 114. The current version of the frame of data is refined (denoised), as previously described, for a next weight generation time step (step 206ba). This is repeated until a final iteration at which the frame of data represents the final set of weights for the target neural network.

The iterative refining (denoising) can, e.g., proceed for a predetermined number of weight generation time steps until a last time step is reached (e.g. time can count down and stop close to or at zero), or it can proceed until a defined target neural network performance criterion is met, determined, e.g., using evaluation examples.

In some implementations the system can make use of classifier-free guidance to generate data item conditioned on the task encoding data 114, e.g. by combining conditional and unconditional denoising output in accordance with a guidance weight; or classifier-type guidance can be used. As previously described, in implementations during the denoising process the denoising neural network system 120 can also be conditioned on data identifying the weight generation time step, e.g. on an embedding of the weight generation time step.

The values of the weights for the target neural network are determined from the frame of data at the final iteration (step 206c). For example, the values of the weights defined by the frame of data at the final iteration can be packaged into a model file for the target neural network 130.

The diffusion model is configured (trained) to output a frame of data that has the correct shape, e.g. rank 2 for a fully-connected or recurrent layer, rank 3 for a convolutional or de-convolutional layer, and so forth. In general weights for any type of neural network layer can be generated in this (or a corresponding) way. For example an attention layer comprises query, key, and value weight matrices, which are each of rank 2.

In some implementations the diffusion model 120 generates a sequence of frames of data, analogously to generating a video. The video can be of a fixed number of frames, e.g. defined by the training. Each frame of data can provide the weights for a different, e.g. successive, layer of the target neural network 130. Then the model weights are generated in sequence and with appropriate interdependencies to perform the specified processing task. The values of the weights defined by the successive (final) frames of data can then be packaged into the model file.

The system 100 can be set up and trained to output frames of data that have different shapes, e.g. rank 2 or rank 3. In some implementations the shape of the output frames of data depends on the model architecture specified by the task description or chosen by the system. In this case the system 100 is trained using training examples to generate frames of data of the required shape. Where multiple target architectures are possible the task encoding data 114 can encode the target architecture, i.e. a specification of the types of layers used in the target architecture.

The system 100 can fine-tune the target neural network 130 by generating fine-tuned weights for one or more layers of the target neural network 130, and/or by generating weights for one or more adapter layers to be added to the target neural network 130. In general the weights are adapted to the particular task (or tasks) specified by the task description 112. The fine-tuned weights can be generated from scratch i.e. from a random initialization of the diffusion process, since the task encoding data 114 provides the necessary information to the denoising neural network system 120. Alternatively the diffusion process can be initialized with pre-trained weights of the target neural network 130 that are to be fine-tuned. One result of the process of FIG. 2 can be fine-tuned weights. Another result of the process of FIG. 2 can be a complete, trained model, i.e. target neural network 130, that is adapted to the specific task (or tasks) defined by the task description 112.

The weight diffusion implemented by the denoising neural network system 120 can benefit from guiding using a feedback signal that represents performance of the target neural network 130 in performing the processing task, e.g. based on a held out (evaluation) dataset. This can help convergence towards an improved set of weights. The feedback signal used to guide the weight diffusion implemented by the denoising neural network system can vary during the weight diffusion process, i.e. as the weights change.

In some implementations generating the set of weights for the target neural network this can involve obtaining a value of a performance metric of the target neural network on the processing task at one or more intermediate weight generation time steps after initializing the frame of data and before the final iteration.

More particularly this can involve, at an intermediate weight generation time step, determining intermediate values of the weights for the target neural network from the frame of data at the intermediate weight generation time step, and processing one or more evaluation data items, using the target neural network 130 with the intermediate values of the weights, to obtain a value of a performance metric of the target neural network on the processing task.

The evaluation data items can be any data items appropriate to evaluating the processing task. In general an evaluation data item can comprise an example input for the target neural network when performing the processing task, and a corresponding example output that is an example of the processing task having been performed on the example input. The performance metric can be any suitable metric, e.g. a measure of accuracy or error on the task, or a value of a loss function or objective function for the processing task.

In one example implementation, at one or more intermediate weight generation time steps after obtaining the value of the performance metric the (trained) denoising neural network system is conditioned on a representation of the performance metric (as well as the task encoding data), when processing a frame of data at a weight generation time step. This can also be done during training of the system (so that the performance metric can afterwards be used in inference). Also or instead, classifier-type diffusion model guidance can be used, e.g. by subtracting from the predicted noise a gradient of a log probability of the evaluation signal with respect to the data, scaled by a weight. As a further alternative, at one or more weight generation time steps multiple possible refined, denoised frames of data can be determined and evaluated, and the best selected for subsequent iterations.

A denoising neural network system as described above can be guided as described independently of use of the language model neural network 110. That is, this technique can be used whether or not the task encoding data 114 is generated by a language model neural network.

Some implementations of the system can determine when to stop the iterative refining early. This can involve, at one or more of the weight generation time steps, determining values of weights for the target neural network from the (current version of the) frame of data at the time step. One or more evaluation data items can then be processed, using the target neural network with values of the weights determined from the frame of data at the time step, to obtain a value of a performance metric of the target neural network, e.g. as previously described.

The system can determine whether to stop iteratively refining the frame of data at the weight generation time step dependent on the value of the performance metric of the target neural network, e.g. by determining when a variation of the performance metric with time step is flattening out, e.g. by determining when a derivative of the variation with respect to time is less than a threshold value; and/or by comparing the performance metric with a threshold value.

Some implementations of the system can use the language model neural network 110 to generate evaluation data items, e.g. example inputs and outputs as described above. In this case the text generation, or multimodal output generation, capability of the language model neural network can be used.

More particularly this can involve receiving one or more examples of an input to the target neural network and a corresponding output from the target neural network that is a result of performing the processing task. A (second) prompt sequence of tokens that represents the one or more examples of the input to the target neural network and the corresponding output can then be processed, using the language model neural network 110, to generate one or more additional examples of the input to the target neural network and the corresponding outputs from the target neural network that is a result of performing the processing task. The one or more additional examples can then be used as one or more of the evaluation data items.

As previously described, in some implementations initialising the frame of data representing the initial set of weights for the target neural network comprises initialising the frame of data to represent an initial, pre-trained set of weights for the target neural network (which need not be all the weights of the target neural network). The system can then fine-tune the initial, pre-trained set of weights by determining updated values for the initial, pre-trained set of weights for the target neural network from the current version of the frame of data at the final iteration. That is, the denoising neural network system can be used to refine the initial, pre-trained set of weights. This can involve adding noise, generally a small amount of noise, to the initialised frame of data representing the pre-trained set of weights. As described further later, some implementations of the system can selectively refine just some of the pre-trained weights of the target neural network.

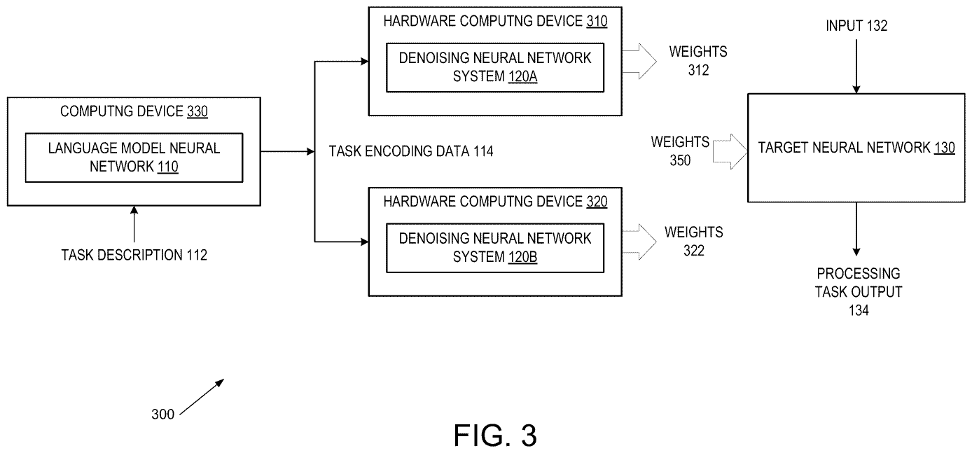

FIG. 3 shows an example of the system 100 adapted for implementation in a parallel processing environment 300. The parallel processing environment 300 comprises a plurality of hardware computing devices 310, 320 configured to operate in parallel. Such an arrangement can be particularly useful where the number of weights to be generated is large.

A hardware computing device can comprise a general purpose processor and/or one or more one or more hardware accelerators as well as, typically, memory. A hardware accelerator can comprise integrated circuitry that performs certain operations, e.g., matrix multiplication, in hardware. For example, the hardware accelerators can be tensor processing units (TPUs), graphics processing units (GPUs), or other machine learning accelerators that perform machine learning operations in hardware.

In a parallel processing environment generating the set of weights for the target neural network involves generating a first set, in particular subset, of the set of weights for the target neural network 130 using a first of the hardware computing devices 310 and, in parallel, generating a second, different set, in particular subset, of the set of weights for the target neural network 130 using a second of the hardware computing devices 320. The process determines the values of weights 350 for the target neural network 130 from both the first set (subset) of weights and the second set (subset) of weights.

More specifically a first denoising neural network system 120A, trained to generate the first set of weights, can be maintained on the first hardware computing device 310, and a second denoising neural network system 120B, trained to generate the second, different set of weights, can be maintained on the second hardware computing device 320. As some examples, the first and second sets of weights can comprise weights for different layers of the target neural network, or weights for different groups of layers of the target neural network, or weights for different adapter neural networks for the target neural network. Optionally the language model neural network 110 can be used to determine which weights of the target neural network should be modified by the system 100.

In some implementations the system 100 determines values of weights of a pair of adapter matrices for LoRA (Hu et al. arXiv:210609685) that are applied in parallel to one or more layers or blocks of the target neural network, e.g. one or more attention layers or blocks. For example, one of the pair of matrices can have an input that corresponds to an input of the layer(s)/block(s) and provide an output that is coupled to an input of the other of the pair of matrices, that can have an output that is combined, e.g. by summing, with an output of the layer(s)/block(s). In general the adapter matrices can have a reduced rank compared to the layer(s)/block(s), e.g. a number of columns (or rows) that is less than a number of dimensions of data processed by the layer(s)/block(s). Such a pair of matrices can be used to fine-tune the target neural network 130, the original weights of which can remain unchanged.

In a parallel implementation as described above each of the first and second hardware devices 310, 320 can perform the previously described steps of initialising and refining a respective frame of data to obtain a respective frame of data representing a final first and second sets of weights. In implementations the first and second denoising neural network systems 120A, B are conditioned on the same task encoding data 114, which can be generated prior to generating the first and second set of weights for the target neural network.

In some implementations a server can be configured to determine values of weights for multiple different target neural networks; this process can be pipelined. This pipelining can involve maintaining the language model neural network 110 on a third computing device 330, different to each of the first and the second hardware computing devices. Then the language model neural network 110 can be used to process a prompt sequence of tokens that defines a second, e.g. different processing task for a second target neural network whilst the task encoding data for the (first) processing task is maintained and used to condition generation of the sets of weights for the (first) target neural network.

Implementations of the above described techniques can require less memory and computational capability than, e.g., updating weights by back-propagation. The described techniques can in principle be partly or wholly implemented on a local computing device, such as a mobile device, that has less memory or computational capability than a remote server. In some implementations fine-tuning of pre-trained weights of the target neural network 130 can be performed locally for privacy and/or to reduce load on the remote server (which may serve many mobile devices). It can also reduce the communications bandwidth that might otherwise be needed for communicating a large number of weights from the remote server to the mobile device.

For example as previously described, determining a fine-tuned set of weights for the target neural network 130 need not involve retrieving the corresponding pre-trained weights from a remote computing system. In some implementations, however, initialising the frame of data can involve a local computing device retrieving the initial, pre-trained set of weights from a remote computing system. In either case, determining a fine-tuned version of the initial, pre-trained set of weights can be performed at the local computing device. The local computing device can have less memory and/or computational capability than the remote computing system.

Also or instead the system can be deployed in an environment that enables users to provide requests for the system to train (which here includes fine-tune) their target neural networks. Users can provide the requests, e.g., by way of a user interface or through an application programming interface (API). The requests can be transmitted from a user device, e.g. over a data communication network such as the Internet, to one or more computers implementing the system, e.g., in a data center.

A request can comprise the task description text 112 (and optionally any multimodal items), and optionally may specify a model, i.e. the target neural network 130 where there is an option to train multiple different target neural networks. In some implementations the request can include the target neural network 130, or a specification thereof, e.g. in terms of an architecture and/or hyperparameters for a particular architecture.

The system 100 can then process the user requests to generate values of weights for a target neural network 130 as described above, and then transmit the weights to the user devices, e.g., over the data communication network.

In implementations where values are determined for only some of the weights of the target neural network 130, e.g. fine-tuning just some of the weights, or where values of weights of an adapter neural network are determined, these can be fixed for a particular target neural network, or can be chosen by a user. In some implementations the language model neural network 110 can be used to determine a good set of weights to fine-tune rather than, e.g., fine-tuning all the weights; this can improve the efficiency of the weight determining process.

For example the (or another) prompt sequence of tokens can be processed using the language model neural network 110 to generate an output sequence of tokens, e.g. text tokens, as well as the task encoding data. Then a number or identity of the initial, pre-trained set of weights for the target neural network 130 can be determined from this output sequence of tokens.

As previously described, in some implementations the system 100 is used for determining values of weights for the target neural network 130 that are a (proper) subset of a larger, e.g. complete, set of weights of the target neural network 130. In some implementations the frame of data can comprise data elements that represent the larger set of weights, e.g. where each data element represents the value of a corresponding one of the larger set of weights.

The system can obtain an indication of a number of weights in the set of weights determined by the system 100. The indication of the number of weights may be a direct indication, e.g. a count of a total number of weights to be updated, or an indirect indication, e.g. defining a number of layers of, or parts of, the target neural network for which values of weights are to be determined. Where it is necessary to determine which weights are to be updated, this can be specified by the user or performed automatically, e.g. as described above.

In some implementations the indication of a number of weights in the set of weights may include data that indicates which weights are to be updated, e.g. a user may define for which weights, layers of, or parts of, the target neural network values of weights are to be determined. In some implementations, but not necessarily, this can involve selecting from a number of discrete options, each of which corresponds to a different group of weights to be updated. Depending, e.g., upon the training the same denoising neural network system 120 may be used to generate each different group of weights, or a separate denoising neural network system 120 may be provided for each group of weights.

In some implementations the system can be configured to obtain an indication of the number of weights in the set of weights from a user, and can then process this indication using a weight selection neural network to identify which weights of the larger set of weights belong to the set of weights to be updated. The weight selection neural network can be a neural network that is dedicated to identifying which weights, or the language model neural network 110 can be trained (fine-tuned) to perform this task.

In some implementations the set of weights for the target neural network 130 can be generated by selectively refining data elements representing the set of weights, in the frame of data that represents the larger set of weights, using the indication of the number of weights in the set of weights. As a particular example, this can involve determining a mask frame that defines data elements of the frame of data corresponding to the set of weights. The frame of data for the weight generation time step can then be processed to refine the frame of data for the next weight generation time using the mask frame to selectively refine the data elements representing the set of weights in the frame of data. Merely as an example, of one way of using a binary mask to define data elements of a frame of data for selective refinement is described in Appendix D of Song et al., arXiv:2303.01469v2, incorporated by reference.

In some implementations the system can comprise first and second denoising neural network systems 120. The first denoising neural network system can be configured for fine-tuning an initial, pre-trained set of weights of the target neural network. The second denoising neural network system can be configured for determining values of weights for one or more adapter neural networks, e.g. a pair of adapter matrices for LoRA as previously described. In some implementations the functions of such first and second denoising neural network systems can be combined into a single denoising neural network system 120.

The adapter neural network can be configured to modify, i.e. adapt, an output generated by a pre-trained neural network part of the target neural network 130. This can be done by specifically modifying (adapting) an output layer of the target neural network 130. Also or instead it can be done by modifying the output of one or more intermediate layers of the target neural network 130.

The language model neural network 110 or another neural network, can be used to select between determining values of weights for the adapter neural network and fine-tuning the initial, pre-trained set of weights of the target neural network. In implementations where there are first and second denoising neural network systems the language model neural network 110, or another neural network, can be used to select one of either the first denoising neural network system or the second denoising neural network system. In some implementations the language model neural network 110, or other neural network, may be implemented on different hardware to the first and denoising neural network systems.

As previously described, in some implementations the target neural network 130 comprises a pre-trained neural network, and can be enhanced by adding one or more adapter neural networks configured to modify (adapt) an output generated by the pre-trained neural network. The output generated by the pre-trained neural network can be modified directly or indirectly, e.g. by using the one or more adapter neural network to modify an input to, or one or more intermediate layers of pre-trained neural network.

In general the adapter neural network has a smaller number of weights than the pre-trained neural network. Determining values of weights for the target neural network 130 can then involve determining values of weights for the adapter neural network from the frame of data at the final iteration. The (other) weights of the pre-trained target neural network 130 can be left unchanged. This process may, but need not, use parallel processing as described.

As one example, the one or more adapter neural networks can comprise a pair of adapter matrices for LoRA. The pre-trained neural network may include one or more attention neural network layers. In this case one or more or each attention layer of the pre-trained neural network can be modified by a respective pair of adapter matrices, to thereby modify the output of the pre-trained neural network. As another example, the adapter neural network can modify the input to or output from one or more blocks of a sequence of blocks of the pre-trained neural network each comprising a sequence of neural network layers. The one or more adapter neural networks can comprise any adapter for a language model neural network (of which there are many known examples).

In implementations of the system that involve determining values of weights for such an adapter neural network, and broadly as previously described, the pre-trained neural network may be maintained on a remote computing system and the adapter neural network may be maintained on a local computing device (in communication with the remote computing system), such as a mobile device of a user of the system. The denoising neural network system 120 can also be maintained on the local computing device, which is used for generating the values of the weights for the adapter neural network. As previously described this can help maintain privacy, and can reduce load on the remote computing system. It can also reduce the communications bandwidth that might otherwise be needed for communicating a large number of weights from the remote computing system to the local computing device. The language model neural network 110 may be, but need not be, implemented on the remote computing system.

In some implementations, and whether or not an adapter neural network is used, determining values of the weights for the target neural network can involve determining the values of the weights, e.g. of all the weights, from scratch.

In some implementations the system can determine a plurality of sets of weights for the target neural network, i.e. a collection of sets of weights. Each set of weights in the collection can then be evaluated to select an optimum set of weights. This can be done by, for each of the final set of weights in the collection, randomly initialising the frame of data representing the initial set of weights, e.g. by sampling from a distribution such as a Gaussian distribution, and generating the frame of data representing the final set of weights by refining the frame of data representing the initial set of weights.

Advantageously this can be done in parallel, e.g. using an implementation of the previously described parallel processing system 300. That is, determining the plurality of sets of weights can involve determining two or more of the sets of weights in parallel on a plurality of hardware computing devices configured to operate in parallel.

The system can evaluate each set of weights in the collection by processing one or more evaluation data items using the target neural network, with values of the weights determined from the set of weights, to obtain a value of a performance metric of the target neural network with the set of weights. The system 100 can then select one of the plurality of sets of weights for determining the values of the weights for the target neural network 130, dependent upon the value of the performance metric for each set of weights in the collection. For example, the system 100 can select a set of weights that provides a greatest accuracy (least error) in the processing task as evaluated on some holdout dataset. Optionally evaluating each set of weights in the collection can involve evaluating two or more of the sets of weights in parallel on the plurality of hardware computing devices.

The frame of data representing the final set of weights for the target neural network 130, i.e. representing the determined values of the weights for a target neural network, can represent the values of the weights according to, e.g. a type of neural network layer for which the weights are intended.

In general the described techniques can be used to determine values of weights for feedforward, convolutional, attention, normalization, or other neural network layers of the target neural network.

For example, in some implementations generating the frame of data representing a final set of weights for the target neural network can involve generating a frame of at least two-dimensional data, in which each data element in a first dimension of the frame corresponds to a node in a layer, e.g. a feedforward layer, and in which each data element in a second dimension of the frame represents a respective weight connecting the node to another node in an adjacent, e.g. previous, layer.

Then determining values of weights for the target neural network from the frame of data at the final iteration can involve determining values of the weights for connections to a node of the target neural network, in the e.g. feedforward layer, from a respective line (row or column) of data elements in the frame of at least two-dimensional data. That is, a 2D frame of data can be used to represent the weights of a feedforward layer.

As another example, a “3D” frame of data can be used to represent the weights of a convolutional layer. In principle a 3D frame of data could also be used to represent the weights of a feedforward layer by leaving one dimension unused. By analogy with image generation, such a 3D frame of data can correspond to an image with multiple, e.g. RGB color channels, or it can correspond to an image with three spatial dimensions. For example, a convolutional (CNN) kernel can be set to be rank 3 and thus a frame of three-dimensional data can define the weights for such a kernel or, more generally, the weights of all the kernels for a CNN layer (e.g. different regions of the frame can define different kernels).

As previously described, generating a 2D or “3D” frame of data can be performed using the denoising neural network system in a manner analogous to generating a 2D or “3D” image. In some implementations a sequence of 2D or 3D frames of data can be generated, i.e. the 2D or 3D frame of data can be extended in a further dimension, analogously to generating a 2D or 3D video. This sequence of frames of data can be used to determine values of weights for multiple layers of the target neural network. This sequence of frames of data can alternatively be generated as a single frame of data with an additional dimension (corresponding to the time dimension of a video), that spans, and indexes, multiple neural network layers of the target neural network 130. As previously indicated, here are many techniques for using a diffusion process to generate video, and that can be used in such implementations of the described system.

There now follows a description of an example training process that can be used to train implementations of the system.

A system 100 as described above can be trained using a dataset comprising examples of weights for the target neural network after having trained, or fine-tuned, the target neural network 130 (or adapter neural network) to perform a range of different processing tasks. The examples for training the system 100 can also include corresponding processing task descriptions (which can include sample data or a target neural network name). Such a dataset may be assembled by training or fine-tuning multiple examples of the target neural network 130 with different weight initializations and for different processing tasks. In general the different processing tasks should correspond to those for which the system will be used in practice. The described model training process can generalize from the different processing tasks seen during training into the new problems, in part because of the typically high capability of the language model neural network 110.

In some implementations the architecture of the target neural network is fixed. In some implementations a discrete number of different architectures of the target neural network (or adapter neural network) may be used. Then the task description text 112 can also specify the target neural network. Where the system is used for a list of supported models (or can define a model), the training dataset should provide coverage of the different models i.e. of different examples of the target neural network 130.

Surprisingly, the system can also be trained using examples of weights for the target neural network (or adapter neural network) along the training path, i.e. prior to optimization of an objective function of the target neural network 130 for a processing task.

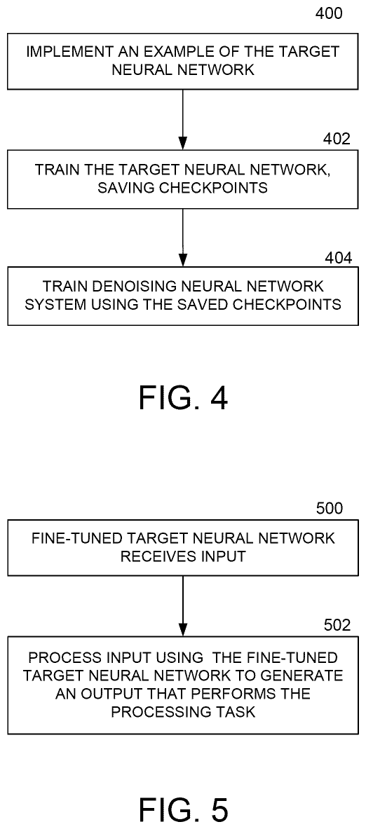

FIG. 4 is a flow diagram of an example process for training a denoising neural network system, and optionally also a language model neural network, for determining values of weights for a target neural network. The process of FIG. 4 may be implemented by one or more computers in one or more locations; it can be used for training the system 100. For convenience the process is described with reference to the system of FIG. 1.

The method involves implementing an example of the target neural network 130 (step 400). The example of the target neural network 130 is trained, e.g. fine-tuned, on a range of particular processing tasks, each defined by a task description. The training (fine-tuning) involves saving checkpoints of the target neural network 130 during the training process (step 402). A checkpoint comprises values of a set of weights of the target neural network. It can also include an associated metric for the target neural network 130, such as a value of the objective function of the target neural network 130 for the processing task that the target neural network 130 is being trained on, or some other training metric such as an accuracy with which the target neural network 130 performs the processing task that the target neural network 130 is being trained on. The denoising neural network system 120 is trained using the saved checkpoints (step 404).

There can be a list of supported models, i.e. target neural networks, and the training data can be curated on those models. The list of supported models can be short.

In some implementations the training can involve receiving and tokenizing task description text 112 that defines a processing task (that the target neural network is being trained to perform), to obtain a prompt sequence of tokens that defines the processing task. The prompt sequence of tokens is processed using a language model neural network to generate task encoding data 114 that encodes the processing task. As previously described, the task description 112 can also include a sample of the training data for the target neural network 130, and/or a name or other identifier of the target neural network 130.

The denoising neural network system 120 can then be trained using the saved checkpoints whilst conditioned on the task encoding data 114 for at least some of the saved checkpoints.

The conditioning data, i.e. the task encoding data 114, can be incorporated during training of the denoising neural network system 120 using, e.g., classifier-based guidance or classifier-free guidance (Ho and Salimans, arXiv:2207.12598). For example, training using classifier free guidance can involve randomly masking out or otherwise removing the conditioning data from the denoising neural network system so as to train the denoising neural network system to generate the estimated frame of data both with and without guidance from the conditioning data.

In a particular example, training the denoising neural network system 120 can involve, for one or more of the saved checkpoints, processing the values of the set of weights in the saved checkpoint with noise added to the values, e.g. according to a weight generation time step, using the denoising neural network system, whilst conditioned on the task encoding data (and a representation of the weight generation time step) to determine a value of a denoising system training loss.

The training of the denoising neural network system 120 can use any diffusion model or consistency model loss. The training data for training the example of the target neural network 130 can be any data appropriate to the task that the target neural network 130 is being trained to perform.

As an example, the denoising neural network system 120 can be conditioned on a representation of a weight generation time step. Determining a loss for training the denoising neural network system can involve processing a values of a set of weights in a checkpoint and noise at a level that depends on the weight generation time step, conditioned on the weight generation time step, to generate an output frame of data. The loss can depend on a difference between the output frame of data and a reference frame of data, such as a frame of applied noise or a frame obtained from a version of the denoising neural network system earlier in the training process.

In implementations the training also involves backpropagating the denoising system training loss through the denoising neural network system 120 and into the language model neural network 110 to update values of trainable parameters, e.g. weights, of both the denoising neural network system 120 and the language model neural network 110. This can help the system 100 to learn suitable intermediate representations for the task encoding data 114.

The language model neural network 110 can be pre-trained, e.g. it can be a general-purpose language model, and can then be fine-tuned by end-to-end training of the system 100 using the denoising system training loss. The denoising system training loss can be, e.g., a diffusion model training loss or a consistency model training loss. This loss can be backpropagated through the denoising neural network system 120 into the language model neural network 110.

Optionally denoising system training loss can include an evaluation loss that evaluates the accuracy (error) of the target neural network 130 on the processing task of an evaluation example. This evaluation loss can comprise the associated metric for the checkpoint, e.g. the training loss, or accuracy of the target neural network 130 for the checkpoint. As another example the evaluation loss can be determined from a held-out portion of the training data used to train the example of the target neural network.

That is, when training the system 100 on saved checkpoints from training the target neural network 130, denoising system training loss can be based on the loss of the target neural network 130 at the checkpoint (for the described processing task).

Broadly, by training the system end-to-end in this way, the system 100 can learn to map the high-level task description 112 (optionally including some sample data, and or the target architecture) to one or more matrices, i.e. frames of data that define fine-tuned weights for the task. For example training the system end-to-end can help to encode information useful for determining the weights, and in implementations also the architecture, of the target neural network 130, into the task encoding data 114.

Where a weight selection neural network (which can be the language model neural network 110) is used to identify which weights of the target neural network to update, the weight selection neural network can be trained by collecting examples of weight selections made by humans with experience of machine learning. Training can also or instead be based on publicly available datasets of model weights.

FIG. 5 is a flow diagram of an example process for performing a processing task using a target neural network 130 that has trainable parameters, e.g. weights, with values that have been determined using the techniques described above with reference to FIG. 2. The process of FIG. 5 may be implemented by one or more computers in one or more locations.

At step 500 the fine-tuned target neural network 130 receives an input 132. The input is processed using the target neural network, in accordance with values of the weights of the target neural network 130 determined as described above, to generate a neural network output, i.e. processing task output 134, that performs the processing task (step 502).

The described techniques can be used to configure, e.g. fine-tune, the target neural network 130 to perform any sort of processing task. Some illustrative examples follow.

As one example the processing task may comprises an image and/or audio processing task. Then receiving the task description text can include receiving a still or moving image, or audio. Tokenizing the task description text can then include tokenizing the image or audio to obtain the prompt sequence of tokens, and hence task encoding data, that defines the image or audio processing task.

As a particular example, the target neural network can be configured to process an image or audio to generate an output that describes a content of the image or audio or that classifies a content, e.g. object, of the image or audio into one or more of a plurality of categories.

As used herein an image, defined by pixels of the image, can be a still or moving image, in monochrome or color (including in non-visible wavelengths), in 2D or in 3D; and can includes a LIDAR point cloud (a “pixel” may then be a point of the point cloud). The image may represent a real world environment, e.g. it may be captured from the real world by a camera or other image sensor, and objects represented in the image may comprise physical real-world objects.

As used herein audio or audio data, which may represent spoken words, can comprise a representation of an audio waveform, e.g. instantaneous amplitude values of the waveform, or a time-frequency representation of the audio waveform, or a spectrogram, e.g. a mel-spectrogram, i.e. an image of a time-frequency representation of the audio waveform.

When the target neural network is configured to generate an image and/or audio, the image/audio may be generated in accordance with a learned distribution that is indirectly specified by the determined weights for the target neural network, and that can correspond to a distribution of images and/or audio in the real world. Optionally the target neural network can have a target neural network conditioning input to specify the distribution, e.g. a type of real-world (image or audio) object represented by the image and/or audio.

As another example, the target neural network can be configured to process an observation of the real world and generate an action selection output for selecting an action to be performed by a mechanical agent in the real-world environment to perform an agent task, e.g. an action to move the agent in the real-world environment to perform the agent task.

In some implementations the target neural network 130 is an LLM, or a multimodal model such as a VLM. In general a multimodal machine learning model can be trained to perform any sort of machine learning task or tasks. After the multimodal machine learning model has been trained it can be deployed for use in performing the machine learning task(s). For instance, the machine learning model can be deployed in an environment that enables users to provide requests for the machine learning model to process specified multimodal inputs to generate corresponding model outputs. Users can provide the requests, e.g., by way of a user interface or through an application programming interface (API). The requests can be transmitted from a user device (e.g., over a data communication network, e.g., the internet) to one or more computers implementing the machine learning model, e.g., in a data center. The machine learning model can process multimodal inputs specified by user requests to generate corresponding model outputs, and then transmit the model outputs to user devices (e.g., over a data communication network).

In some implementations, after training, a particular task that is to be performed by the multimodal machine learning model, i.e. the fine-tuned target neural network 130, can be described by part or all of the sequence of text in the multimodal input to the model. For example in a multimodal input that includes an image, video, or audio item such a prompt might specify “Generate a caption”, “Generate a description”, “Answer the following question: [about the image, video, or audio item]”, or “Detect a person”. Where the model is used for an agent control task a prompt may define “Take the knife out of the drawer”, or “Q: What action should the robot take to take the knife out of the drawer?”. Also or instead such a prompt may give one or more examples of a task to be performed. A multimodal machine learning model can be trained on multiple natural and/or computer languages and the prompt may then specify a language to use.

A few examples of some machine learning tasks that can be performed by a model, i.e. the target neural network 130, trained, e.g. fine-tuned, as described herein follow.

For some tasks the second modality input represents an image or video as previously described, e.g. from a camera or other imaging device that captures the image or video from a real-world environment, and/or audio, e.g. audio data such as speech or other sounds captured from a real-world environment. In general the tasks described below may be tasks that require spatial awareness or other context from the image, video, or audio item. For example, a prompt may ask “What is the object in the top left corner?”, or “What was the answer to the spoken question?”.

As one example the task may comprise an object or action detection task. A task-specific training data item may comprise an image, video, or audio item containing one or more objects or actions, and a sequence of text. The sequence of text may describe or otherwise label the object(s) or action(s) and (for an image or video) may include text giving bounding box coordinates for the object(s) or action(s). After training, when the model is used in inference, the model output 122 may comprise or represent text that describes or otherwise labels detected object(s) or action(s) in the second modality input, and may (for an image or video) include bounding-box coordinates for the detected object(s) or action(s), e.g. “10 20 90 100 cat 20 30 100 100 dog”.

As another example the task may comprise a classification task, e.g. an object or action classification task. A task-specific training data item may comprise an image, video, or audio item containing one or more objects or actions and a sequence of text. The sequence of text may describe or otherwise classify the object(s) or action(s). After training, when the model is used in inference, the model output may comprise data, e.g. text, that classifies the object(s) or action(s) in the second modality input into one of a plurality of classes.

As another example the task may comprise an image, video, or audio item describing a task, e.g. a captioning task (which, as used here, includes an audio description task to explain what is happening in a video). A task-specific training data item may comprise an image, video, or audio item and a sequence of text describing the image, video, or audio item. After training, when the model is used in inference, the model output may comprise data, e.g. text, describing an image, video, or audio item in the second modality input. For example the model output may provide a caption or description for a second modality input item, or it may count objects in the second modality input item, or it may provide some other form of description of the second modality input item.

As another example the task may comprise an image, video, or audio question-answering task. A task-specific training data item may comprise an image, video, or audio item and a sequence of text that describes the image, video, or audio item. After training, when the model is used in inference, the model output may comprise data, e.g. text, that answers a question about the second modality input specified in a prompt sequence of text, e.g. as described above. This may be used, e.g., to answer questions about visual plots and charts or about sounds.

As another example the task may comprise a character or word recognition task, e.g. an OCR (optical character recognition) task. A task-specific training data item may comprise an image, video, or audio item and a sequence of text that includes text that is depicted in the image or video, or that is represented as speech in the audio item. After training, when the model is used in inference, the model output may comprise text that represents characters or words in the second modality input, e.g. in a natural language.

As another example the task may comprise a still or moving image or audio generation task. A task-specific training data item may comprise an image, video, or audio item and a sequence of text that describes the image, video, or audio item. After training, when the model is used in inference, the model output may comprise data for an image, video, or audio item, e.g. image data defining values for pixels of a still or moving image or audio data representing values of an audio waveform, and the sequence of text in the multimodal input to the model may describe or characterize the image, video, or audio item to be generated.

As another example the task may comprise a computer language text generation task. A task-specific training data item may comprise an image, video, or audio item and a sequence of text in a computer language for generating the image, video, or audio item. After training, when the model is used in inference, the model output may comprise text in the or another computer language for generating or rendering an image, video, or audio item in the second modality input, e.g. a web page, plot, or chart.

In another example of a computer language text generation task a task-specific training data item may comprise an image, video, or audio item and a sequence of text in a computer language for performing a task in relation to the image, video, or audio item, e.g. a data processing task that involves analyzing the content of the image, video, or audio item to provide a result of the analysis or, e.g., a search to search for information relating to the content of the image, video, or audio item. The computer language in the model output may comprise computer language for invoking a function or calling one or more external APIs. Merely as one example, such an output may be formatted as a JSON object. As previously, the sequence of text in the multimodal input may define the task to be performed and the second modality input may comprise, e.g. an image, video, or audio item in relation to which the task is to be performed, e.g. a task that involves manipulation of particular types of data that may benefit from access to an API such as mathematical data, date/time related data, scientific data, recent data that may post-date training of the model (that may be accessed by a search function or API), and so forth. After training, when the model is used in inference, the model output may comprise text in the or another computer language for performing a task, e.g. as described above, in relation to an image, video, or audio item in the second modality input. The method may then include using the text in the computer language to perform the task.

In general where the model output comprises text this may be provided as speech representing the text.

In some implementations the machine learning task comprises an agent control task in which the agent interacts with an environment to perform the agent control task. In these implementations the multimodal input includes an observation characterizing the environment. For example the multimodal input can include a sequence of text that defines the task to be performed by the agent and the second modality input can represents an image, video, audio, or other observation of the environment, e.g. captured by a camera or other imaging device, or by a microphone, from a real-world environment. A task-specific training data item may comprise a sequence of text representing one or more actions of the agent, and a second modality input representing an observation of the environment. After training, when the model is used in inference, the model output comprises an action selection output, e.g. including text, that is used to select one or more actions to be performed by the agent in the environment in response to the observation. As an illustration the model output 122 may define an action as text such as “A: 132 114 128 5 25 156”, that can be converted into a control signal for a mechanical agent, such as a robot, e.g. “ΔT=[0.1, −0.2, 0]ΔR=[10°, 25°, −7°]”. As another example the action selection output may also or instead define one or more low-level skills, e.g. from a vocabulary of previously learnt skills. As before, the sequence of text in the multimodal input to the model may describe the task to be performed, e.g. “What action should the robot take to [perform task]”.

In some agent control implementations, the environment is a real-world environment and the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot or other mechanical agent interacting with the environment to accomplish a specific task, e.g., to locate or manipulate an object of interest in the environment or to move an object of interest to a specified location in the environment or to navigate to a specified destination in the environment. In these implementations, the observations may include, e.g., one or more of: images, object position data, and sensor data to capture observations as the agent interacts with the environment. The actions may define control signals to control the robot or other mechanical agent, e.g., positions, torques, or other control signals for the parts of the mechanical agent, or higher-level control commands.

In some agent control implementations the agent can be a software agent, i.e. a computer program, configured to perform a task. Some examples where the agent is a software agent now follow.

As one example the environment may be an integrated circuit design and the task may be a routing task for routing interconnection lines of the integrated circuit. The observations may be of component positions and/or interconnections, and the actions may comprise component placing or interconnect routing actions. An integrated circuit with interconnection lines routed as determined may then be fabricated.

As another example the environment may be a real-world computing environment and the task may be to manage the distribution of jobs or tasks across computing resources e.g. on a mobile device and/or in a data center. The observations may include observations of computing resources such as compute or memory capacity, or Internet-accessible resources, or that relate to the operation of the computing resources in processing the jobs or tasks; and the actions may include assigning jobs or tasks to particular computing resources.

As another example the environment may be a real-world computing environment and the task is to manage the processing, e.g. by one or more real-world servers, of a queue of continuously arriving jobs. The observations may comprise observations of the times of departures of successive jobs, or the time intervals between the departures of successive jobs, or the time a server takes to process each job, or the arrival times, or time intervals between the arrivals, of successive jobs, or data characterizing the type of job(s). The actions may comprise actions that allocate particular jobs to particular computing resources.

As another example the environment may comprise a real-world computer system or network and the task may be to maintain security of the computer system or network. The observations may comprise any observations characterizing operation of the computer system or network, and the actions may comprise actions to control the operation e.g. to limit or correct abnormal or undesired operation e.g. because of the presence of a virus or other security breach.

As another example the environment may comprise a data packet communications network environment, and the task may be to route packets of data over the communications network. The actions may comprise data packet routing actions and the observations may comprise, e.g., observations of a routing table which includes routing metrics such as a metric of routing path length, bandwidth, load, hop count, path cost, delay, maximum transmission unit (MTU), and reliability.

In some agent control implementations the agent may be a human agent and the environment may be a real-world environment. For example the agent can be a human user of a digital assistant such as a smart speaker, smart display, or some other device that is used to instruct the user to perform actions. The task may be any real-world task that the user wishes to perform. The observations may be obtained from an observation capture subsystem, e.g. a monitoring system such as a video camera or sound capture system, to capture visual and/or audio observations of the user performing the task. The actions may comprise instructions in the form of, e.g., text, image, video, or audio data such as speech, that guide the user in performing the task.

Training the target neural network 130 to obtain training data for the denoising neural network system is now described.

The target neural network 130 may be trained to perform a computational task on an input data item, to generate a corresponding output data item. The loss function for training the target neural network 130 is chosen based on the computational task the target neural network is to perform.

This training can be used to obtain training data for training the denoising neural network system 120, and in implementations also the language neural network 110.

For example, the loss function for training the target neural network 130 may be based on one or more training data items (representing possible input data items to the target neural network), one or more corresponding target data items associated with the one or more training data items (i.e. the corresponding results of performing the computational task on the training data items), and one or more corresponding output data items generated by the target neural network with the current parameters upon receiving the one or more training data items (i.e. the actual outputs of the target neural network upon receiving the training data items). The loss function may indicate the discrepancy between the target data items and the output data items.

The training data items may, for example, consist of one of the following: image data items, encoding one or more still images; video data items, encoding a video sequence of images; audio data items, i.e. data representing sound (e.g. generated sound or sound received by a microphone); sensor data items, encoding the output of at least one sensor describing a state of an environment; or text data items encoding a sample of natural language text. When the trained target neural network is in use and being used to perform the computational task, the input data items to the target neural network are data items of the same sort (i.e. data items consisting of data in the same one of the five categories).

In certain cases, the training data items, and the input data items when the network is in use following training to perform the computational task, may comprise data items which comprise data in more than one of these categories (e.g. data items including both text data and associated image and/or video and/or sound data, such as text describing, or asking a question about, content of the image and/or video and/or sound data; or data items including associated image and/or video data and associated sound data, such as sounds encoding a voice describing, or asking a question about, content of the image and/or video data). Target neural networks configured to receive input data items which comprise data in more than one format (e.g. more than one of the five categories listed above), that is “multi-modal inputs”, are referred to as “multi-modal networks”.

Weights for the target neural network 130 can be determined so that the target neural network can perform classification type tasks. Thus, an output data item generated by the target neural network upon receiving an input data item is data indicating that the input data item is in a specified one of a plurality of classes. The target data items and output data items may be in the form of a one-hot vector (a vector in which the element corresponding to the correct class/selection is set to 1 and all other elements set to 0).

For example, where the input data item comprises an image, i.e. image data that defines pixels of an image, the target neural network can be adapted for objection classification, that is to predict or determine an object that is present in the image data. In another example, the task may be object detection, that is, to determine whether an aspect of the image data, such as a pixel or region, is part of an object. Another image-based task may be pose estimation of an object. The data item may be a video data item. Possible video tasks include action recognition, that is, to determine what action is being performed in a video or a segment (aspect) of a video, and action detection to determine whether an action is being performed in a segment of video. The data item may be an audio data item. Possible audio tasks on audio data items include speech recognition and speaker recognition amongst others.

In the case of an image data item, which as used here includes a video data item, the tasks may include any sort of image processing or vision task such as an image classification or scene recognition task, an image segmentation task e.g. a semantic segmentation task, an object localization or detection task, a depth estimation task. When performing such a task the input may comprise or be derived from pixels of the image. For an image classification or scene recognition task the output may comprise a classification output providing a score for each of a plurality of image or scene categories e.g. representing an estimated likelihood that the input data item or an object or element of the input data item, or an action within a video data item, belongs to a category. For an image segmentation task the output may comprise, for each pixel, an assigned segmentation category or a probability that the pixel belongs to a segmentation category, e.g. to an object or action represented in the image or video. For an object localization or detection task the output may comprise data defining coordinates of a bounding box or region for one or more objects represented in the image. For a depth estimation task the output may comprise, for each pixel, an estimated depth value such that the output pixels define a (3D) depth map for the image. Such tasks may also contribute to higher level tasks e.g. object tracking across video frames; or gesture recognition i.e. recognition of gestures that are performed by entities depicted in a video.

Another example image processing task may include an image keypoint detection task in which the output comprises the coordinates of one or more image keypoints such as landmarks of an object represented in the image, e.g. a human pose estimation task in which the keypoints define the positions of body joints. A further example is an image similarity determination task, in which the output may comprise a value representing a similarity between two images, e.g. as part of an image search task.

In general the target neural network 130 can be configured to receive any kind of digital data input (as the input data item) and to generate any kind of score, classification, or regression output based on the input.

For example, if the inputs to the target neural network 130 are images or features that have been extracted from images, the output generated by the target neural network for a given image may be scores for each of a set of object categories, with each score representing an estimated likelihood that the image contains an image of an object belonging to the category.

As another example, if the inputs to the target neural network 130 are Internet resources (e.g., web pages), documents, or portions of documents or features extracted from Internet resources, documents, or portions of documents, the output generated by the target neural network for a given Internet resource, document, or portion of a document may be a score for each of a set of topics, with each score representing an estimated likelihood that the Internet resource, document, or document portion is about the topic.

As another example, if the inputs to the target neural network 130 are features of an impression context for a particular advertisement, the output generated by the target neural network may be a score that represents an estimated likelihood that the particular advertisement will be clicked on.

As another example, if the inputs to the target neural network 130 are features of a personalized recommendation for a user, e.g., features characterizing the context for the recommendation, e.g., features characterizing previous actions taken by the user, the output generated by the target neural network may be a score for each of a set of content items, with each score representing an estimated likelihood that the user will respond favorably to being recommended the content item.

As another example, if the input to the target neural network 130 is a sequence of text in one language, the output generated by the target neural network may be a score for each of a set of pieces of text in another language, with each score representing an estimated likelihood that the piece of text in the other language is a proper translation of the input text into the other language.

As another example, if the input to the target neural network is an audio data item which is a sequence representing a spoken utterance, the output generated by the target neural network may be a score for each of a set of pieces of text, each score representing an estimated likelihood that the piece of text is the correct transcript for the utterance. As another example, if the input to the target neural network 130 is a sequence representing a spoken utterance, the output generated by the target neural network 130 can indicate whether a particular word or phrase (“hotword”) was spoken in the utterance. As another example, if the input to the target neural network is a sequence representing a spoken utterance, the output generated by the target neural network can identify the natural language in which the utterance was spoken. Thus in general the network input 132 may comprise audio data for performing an audio processing task and the network output 134 may provide a result of the audio processing task e.g. to identify a word or phrase or to convert the audio to text.

As another example, the processing task can be a health prediction task, where the input is a sequence derived from electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

In another example, the output data items may be data for controlling an agent and the input data items are “observations” of the state of an environment. The output data items may comprise data indicative of an action to be performed by the agent or a selection of a policy from which actions to be performed by the agent are selected.

In implementations, the observation may relate to a real-world environment and the selected action relates to an action to be performed by a mechanical agent, such as an electromechanical agent (e.g. a robot), which moves (by translation and/or by reconfiguration of the agent) within the environment. The agent may interact with the environment to accomplish a task, e.g. a robot manipulating objects in the environment, or an autonomous or semi-autonomous land or air or water vehicle navigating through the environment. In another example, the agent may be a control system for an industrial facility.

The input data items may be a sequence of observations or other data characterizing states of an environment, e.g. a video sequence, and the output data items defines an action to be performed by the agent in response to the most recent input data item in the sequence.

At each time step, the state of the environment at the time step depends on the state of the environment at the previous time step and the action performed by the agent at the previous time step.

In general the observations (input data items) may include, for example, one or more of images, object position data, and sensor data to capture observations as the agent interacts with the environment, for example sensor data from an image, distance, or position sensor or from an actuator. In the case of a robot or other mechanical agent or vehicle the observations may similarly include one or more of the position, linear or angular velocity, force, torque or acceleration, and global or relative pose of one or more parts of the agent.

The actions may comprise control inputs to control a physical behavior of the mechanical agent e.g. robot, e.g., torques for the joints of the robot or higher-level control commands; or to control the autonomous or semi-autonomous land or air or sea vehicle, e.g., torques to the control surface or other control elements of the vehicle or higher-level control commands.

In some applications the environment is a networked system and the actions comprise configuring settings of the networked system that affect the energy efficiency or performance of the networked system. The networked system may be e.g. an electric grid or a data center.

In some applications the agent is a software agent, as an example which manages distribution of tasks across computing resources e.g. on a mobile device and/or in a data center. In these implementations, the observations may include observations of computing resources such as compute and/or memory capacity, or Internet-accessible resources; and the actions may include assigning tasks to particular computing resources. The reward(s) or cost(s) may be to maximize or limit one or more of: utilization of computing resources, electrical power, bandwidth, and computation speed.

In some applications the target neural network 130 is, or is part of, an adversarial model, such as an image generation model. The adversarial model may be any type of adversarial model, e.g. a generative adversarial network (GAN).

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The essential elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Further aspects of the invention are defined in the following clauses:
1. A method implemented by one or more computers for determining values of weights for a target neural network, the method comprising:
   receiving task description text that defines a processing task that the target neural network should perform;
   tokenizing the task description text to obtain a prompt sequence of tokens that defines the processing task;
   processing the prompt sequence of tokens using a language model neural network to generate task encoding data that encodes the processing task;
   generating a set of weights for the target neural network by:
   initialising a frame of data comprising data elements representing an initial set of weights for the target neural network, and
   generating a frame of data representing a final set of weights for the target neural network for performing the processing task by iteratively refining the frame of data, the iterative refining comprising, at each of a succession of weight generation time steps:
      processing the frame of data for the weight generation time step using a denoising neural network system conditioned on the task encoding data, to refine the frame of data for a next weight generation time step, until a final iteration at which the frame of data represents the final set of weights for the target neural network; and
   determining values of weights for the target neural network from the frame of data at the final iteration.
2. The method of clause 1, wherein generating the task encoding data comprises:
   processing the prompt sequence of tokens using the language model neural network to generate, in turn, features representing successive tokens of an output sequence of tokens, and
   obtaining the task encoding data from the features of one or more tokens of the output sequence of tokens.
3. The method of clause 1, implemented in a parallel processing system comprising a plurality of hardware computing devices configured to operate in parallel, the method comprising:
   generating a first set of weights for the target neural network using a first of the hardware computing devices and, in parallel
   generating a second, different set of weights for the target neural network using a second of the hardware computing devices; and
   determining the values of weights for the target neural network from both the first set of weights and the second set of weights.
4. The method of clause 3, comprising:
   generating the task encoding data prior to generating the first and second sets of weights for the target neural network; and
   generating the first set of weights and the second set of weights in parallel using the same task encoding data, after generating the task encoding data.
5. The method of clause 4, comprising maintaining the language model neural network on a third computing device, different to each of the first and the second hardware computing devices.
6. The method of clause 1, wherein generating the set of weights for the target neural network further comprises, at one or more intermediate weight generation time steps after initializing the frame of data and before the final iteration:
   determining intermediate values of the weights for the target neural network from the frame of data at the intermediate weight generation time step;
   processing one or more evaluation data items, using the target neural network with the intermediate values of the weights, to obtain a value of a performance metric of the target neural network for the processing task, and at one or more intermediate weight generation time steps thereafter
   processing the frame of data for the weight generation time step using the denoising neural network system conditioned on both the task encoding data and a representation of the performance metric.
7. The method of clause 1, comprising determining when to stop the iterative refining by, at one or more of the weight generation time steps:
   determining values of weights for the target neural network from the frame of data at the time step,
   processing one or more evaluation data items, using the target neural network with values of the weights determined from the frame of data at the time step, to obtain a value of a performance metric of the target neural network, and
   determining whether to stop iteratively refining the frame of data at the weight generation time step dependent on the value of the performance metric of the target neural network.
8. The method of clause 6, further comprising:
   receiving one or more examples of an input to the target neural network and a corresponding output from the target neural network that is a result of performing the processing task;
   processing a second prompt sequence of tokens that represents the one or more examples of the input to the target neural network and the corresponding output, using the language model neural network to generate one or more additional examples of the input to the target neural network and the corresponding outputs from the target neural network that is a result of performing the processing task; and
   using the one or more additional examples as one or more of the evaluation data items.
9. The method of clause 1, wherein initialising the frame of data representing the initial set of weights for the target neural network comprises:
   initialising the frame of data to represent an initial, pre-trained set of weights for the target neural network; the method further comprising:
   fine-tuning the initial, pre-trained set of weights by determining updated values for the initial, pre-trained set of weights for the target neural network from the current version of the frame of data at the final iteration.
10. The method of clause 9, wherein
   initialising the frame of data comprises a local computing device retrieving the initial, pre-trained set of weights from a remote computing system; and wherein
   fine-tuning the initial, pre-trained set of weights is performed at the local computing device.
11. The method of clause 9, wherein:
   processing the prompt sequence of tokens using the language model neural network to generate the task encoding data includes generating an output sequence of tokens, the method further comprising:
   determining a number or identity of the initial, pre-trained set of weights for the target neural network from the output sequence of tokens.
12. The method of clause 1, used for determining values of weights for the target neural network that are a subset of a larger set of weights of the target neural network, wherein the frame of data comprises data elements representing the larger set of weights, the method further comprising:
   obtaining an indication of a number of weights in the set of weights; and
   generating the set of weights for the target neural network by selectively refining data elements representing the set of weights, in the frame of data that represents the larger set of weights, using the indication of the number of weights in the set of weights.
13. The method of clause 12, comprising:
   obtaining from a user an indication of the number of weights in the set of weights; and
   processing the indication of the number of weights using a weight selection neural network to identify which weights of the larger set of weights belong to the set of weights.
14. The method of clause 12, comprising:
   determining a mask frame that defines data elements of the frame of data corresponding to the set of weights; and wherein
   processing the frame of data for the weight generation time step to refine the frame of data for the next weight generation time includes using the mask frame to selective refine the data elements representing the set of weights in the frame of data.
15. The method of clause 1, comprising:
   maintaining first and second denoising neural network systems, the first denoising neural network system for fine-tuning an initial, pre-trained set of weights of the target neural network, the second denoising neural network system for determining values of weights for an adapter neural network configured to modify an output generated by a pre-trained neural network part of the target neural network; and
   using the language model neural network to select between determining values of weights for the adapter neural network and fine-tuning the initial, pre-trained set of weights of the target neural network.
16. The method of clause 1, wherein the target neural network comprises a pre-trained neural network and an adapter neural network configured to modify an output generated by the pre-trained neural network, wherein the adapter neural network has a smaller number of weights than the pre-trained neural network; and wherein
   determining values of weights for the target neural network comprises determining values of weights for the adapter neural network from the current version of the frame of data at the final iteration.
17. The method of clause 16, comprising:
   maintaining the pre-trained neural network on a remote computing system;
   maintaining the adapter neural network on a local computing device in communication with the remote computing system;
   maintaining the denoising neural network system on the local computing device; and
   generating, on the local computing device, the values of the weights for the adapter neural network.
18. The method of clause 1, comprising:
   determining a collection comprising a plurality of sets of weights for the target neural network by, for each of the final set of weights in the collection:
      randomly initialising the frame of data representing the initial set of weights, and
      generating the frame of data representing the final set of weights by refining the frame of data representing the initial set of weights;
   evaluating each set of weights in the collection by processing one or more evaluation data items using the target neural network with values of the weights determined from the set of weights to obtain a value of a performance metric of the target neural network with the set of weights; and
   selecting one of the plurality of sets of weights for determining the values of the weights for the target neural network, dependent upon the value of the performance metric for each set of weights in the collection.
19. The method of clause 18, implemented in a parallel processing system comprising a plurality of hardware computing devices configured to operate in parallel, and wherein
   determining the collection comprising the plurality of sets of weights comprises determining two or more of the sets of weights in parallel on the plurality of hardware computing devices.
20. The method of clause 1, wherein generating the frame of data representing a final set of weights for the target neural network comprises:
   generating a frame of at least two-dimensional data in which each data element in a first dimension of the frame corresponds to a node and in which each data element in a second dimension of the frame represents a respective weight connecting the node to another node; and wherein
   determining values of weights for the target neural network from the frame of data at the final iteration comprises determining values of the weights for connections to a node of the target neural network from a respective line of data elements in the frame of at least two-dimensional data.
21. The method of clause 1, wherein generating a frame of data representing a final set of weights for the target neural network comprises:
   generating a frame of at least three-dimensional data; and
   determining values of weights of one or more convolutional kernels for the target neural network from the frame of at least three-dimensional data.
22. The method of clause 20, used for determining values of weights for a plurality of layers of the target neural network, comprising:
   generating a sequence of frames of data in which an additional dimension of the sequence of frames of data corresponds to layers of the plurality of layers; and
   determining values of weights for the plurality of layers of the target neural network from the sequence of frames of data.
23. A method of training a denoising neural network system for determining values of weights for a target neural network, comprising:
   implementing an example of the target neural network;
   training the example of the target neural network, comprising
      saving checkpoints of the target neural network during the training, a checkpoint comprising values of a set of weights of the target neural network; and
   training the denoising neural network system using the saved checkpoints.
24. The method of clause 23, comprising training the example of the target neural network to perform a processing task; the method further comprising:
   receiving task description text that defines the processing task;
   tokenizing the task description text to obtain a prompt sequence of tokens that defines the processing task; and
   processing the prompt sequence of tokens using a language model neural network to generate task encoding data that encodes the processing task; and wherein
   training the denoising neural network system using the saved checkpoints comprises, for one or more of the saved checkpoints:
   processing the values of the set of weights in the saved checkpoint with noise added to the values, using the denoising neural network system, and whilst conditioned on the task encoding data to determine a value of a denoising system training loss; and
   backpropagating the denoising system training loss through the denoising neural network system and into the language model neural network to update values of trainable parameters of both the denoising neural network system and the language model neural network.
25. The method of clause 1, wherein
   the processing task comprises an image or audio processing task,
   the task encoding data encodes the image or audio processing task,
   receiving the task description text further comprises receiving an image or audio, and
   tokenizing the task description text includes tokenizing the image or audio to obtain the prompt sequence of tokens that defines the image or audio processing task.
26. The method of clause 1, wherein
   the processing task comprises an image or audio processing task, and wherein
   the target neural network is configured to process an image or audio to generate an output that describes a content of the image or audio or that classifies a content of the image or audio into one or more of a plurality of categories.
27. A method of performing a processing task using a target neural network, comprising:
   obtaining an input for the target neural network; and
   processing the input using the target neural network and in accordance with values of the weights of the target neural network as determined by the method of clause 1, to generate a neural network output that performs the processing task.
28. One or more non-transitory computer storage media storing instructions that when executed by one or more computers cause the one or more computers to perform operations of the respective method of clause 1.
29. A system comprising one or more computers and one or more storage devices communicatively coupled to the one or more computers, wherein the one or more storage devices store instructions that, when executed by the one or more computers, cause the one or more computers to perform operations of the respective method of clause 1.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method implemented by one or more computers for determining values of weights for a target neural network, the method comprising:
receiving task description text that defines a processing task that the target neural network should perform;
tokenizing the task description text to obtain a prompt sequence of tokens that defines the processing task;
processing the prompt sequence of tokens using a language model neural network to generate task encoding data that encodes the processing task;
generating a set of weights for the target neural network by:
initialising a frame of data comprising data elements representing an initial set of weights for the target neural network, and
generating a frame of data representing a final set of weights for the target neural network for performing the processing task by iteratively refining the frame of data, the iterative refining comprising, at each of a succession of weight generation time steps:
processing the frame of data for the weight generation time step using a denoising neural network system conditioned on the task encoding data, to refine the frame of data for a next weight generation time step, until a final iteration at which the frame of data represents the final set of weights for the target neural network; and
determining values of weights for the target neural network from the frame of data at the final iteration.

2. The method of claim 1, wherein generating the task encoding data comprises:
processing the prompt sequence of tokens using the language model neural network to generate, in turn, features representing successive tokens of an output sequence of tokens, and
obtaining the task encoding data from the features of one or more tokens of the output sequence of tokens.

3. The method of claim 1, implemented in a parallel processing system comprising a plurality of hardware computing devices configured to operate in parallel, the method comprising:
generating a first set of weights for the target neural network using a first of the hardware computing devices and, in parallel
generating a second, different set of weights for the target neural network using a second of the hardware computing devices; and
determining the values of weights for the target neural network from both the first set of weights and the second set of weights.

4. The method of claim 3, comprising:
generating the task encoding data prior to generating the first and second sets of weights for the target neural network; and
generating the first set of weights and the second set of weights in parallel using the same task encoding data, after generating the task encoding data.

5. The method of claim 4, comprising maintaining the language model neural network on a third computing device, different to each of the first and the second hardware computing devices.

6. The method of claim 1, wherein generating the set of weights for the target neural network further comprises, at one or more intermediate weight generation time steps after initializing the frame of data and before the final iteration:
determining intermediate values of the weights for the target neural network from the frame of data at the intermediate weight generation time step;
processing one or more evaluation data items, using the target neural network with the intermediate values of the weights, to obtain a value of a performance metric of the target neural network for the processing task, and at one or more intermediate weight generation time steps thereafter
processing the frame of data for the weight generation time step using the denoising neural network system conditioned on both the task encoding data and a representation of the performance metric.

7. The method of claim 1, comprising determining when to stop the iterative refining by, at one or more of the weight generation time steps:
determining values of weights for the target neural network from the frame of data at the time step,
processing one or more evaluation data items, using the target neural network with values of the weights determined from the frame of data at the time step, to obtain a value of a performance metric of the target neural network, and
determining whether to stop iteratively refining the frame of data at the weight generation time step dependent on the value of the performance metric of the target neural network.

8. The method of claim 6, further comprising:
receiving one or more examples of an input to the target neural network and a corresponding output from the target neural network that is a result of performing the processing task;
processing a second prompt sequence of tokens that represents the one or more examples of the input to the target neural network and the corresponding output, using the language model neural network to generate one or more additional examples of the input to the target neural network and the corresponding outputs from the target neural network that is a result of performing the processing task; and
using the one or more additional examples as one or more of the evaluation data items.

9. The method of claim 1, wherein initialising the frame of data representing the initial set of weights for the target neural network comprises:
initialising the frame of data to represent an initial, pre-trained set of weights for the target neural network; the method further comprising:
fine-tuning the initial, pre-trained set of weights by determining updated values for the initial, pre-trained set of weights for the target neural network from the current version of the frame of data at the final iteration.

10. The method of claim 9, wherein
initialising the frame of data comprises a local computing device retrieving the initial, pre-trained set of weights from a remote computing system; and wherein
fine-tuning the initial, pre-trained set of weights is performed at the local computing device.

11. The method of claim 9, wherein:
processing the prompt sequence of tokens using the language model neural network to generate the task encoding data includes generating an output sequence of tokens, the method further comprising:
determining a number or identity of the initial, pre-trained set of weights for the target neural network from the output sequence of tokens.

12. The method of claim 1, used for determining values of weights for the target neural network that are a subset of a larger set of weights of the target neural network, wherein the frame of data comprises data elements representing the larger set of weights, the method further comprising:
obtaining an indication of a number of weights in the set of weights; and
generating the set of weights for the target neural network by selectively refining data elements representing the set of weights, in the frame of data that represents the larger set of weights, using the indication of the number of weights in the set of weights.

13. The method of claim 12, comprising:
obtaining from a user an indication of the number of weights in the set of weights; and
processing the indication of the number of weights using a weight selection neural network to identify which weights of the larger set of weights belong to the set of weights.

14. The method of claim 12, comprising:
determining a mask frame that defines data elements of the frame of data corresponding to the set of weights; and wherein
processing the frame of data for the weight generation time step to refine the frame of data for the next weight generation time includes using the mask frame to selective refine the data elements representing the set of weights in the frame of data.

15. The method of claim 1, wherein the target neural network comprises a pre-trained neural network and an adapter neural network configured to modify an output generated by the pre-trained neural network, wherein the adapter neural network has a smaller number of weights than the pre-trained neural network; and wherein
determining values of weights for the target neural network comprises determining values of weights for the adapter neural network from the current version of the frame of data at the final iteration.

16. The method of claim 1, comprising:
determining a collection comprising a plurality of sets of weights for the target neural network by, for each of the final set of weights in the collection:
randomly initialising the frame of data representing the initial set of weights, and
generating the frame of data representing the final set of weights by refining the frame of data representing the initial set of weights;
evaluating each set of weights in the collection by processing one or more evaluation data items using the target neural network with values of the weights determined from the set of weights to obtain a value of a performance metric of the target neural network with the set of weights; and
selecting one of the plurality of sets of weights for determining the values of the weights for the target neural network, dependent upon the value of the performance metric for each set of weights in the collection.

17. The method of claim 1, further comprising performing a processing task using the target neural network, comprising:
obtaining an input for the target neural network; and
processing the input using the target neural network and in accordance with determined values of the weights of the target neural network, to generate a neural network output that performs the processing task.

18. A system implemented by one or more computers for determining values of weights for a target neural network, the system comprising:
a language model neural network configured to:
receive task description text that defines a processing task that the target neural network should perform; and
process a representation of the task description text to generate task encoding data that encodes the processing task; and
a denoising neural network system configured to generate a frame of data representing a final set of weights for the target neural network for performing the processing task by iteratively refining the frame of data, the iterative refining comprising, at each of a succession of weight generation time steps:
processing a frame of data for the weight generation time step, conditioned on the task encoding data, to refine the frame of data for a next weight generation time step, until a final iteration at which the frame of data represents the final set of weights for the target neural network, wherein the values of the weights for the target neural network are determined by the frame of data at the final iteration.

19. The system of claim 18, further comprising the target neural network, wherein the target neural network is configured to perform a processing task by:
obtaining a target neural network input; and
processing the target neural network input using the target neural network and in accordance with the determined values of the weights of the target neural network, to generate a target neural network output that performs the processing task.

20. A system implemented by one or more computers for performing a processing task, the system comprising:
a target neural network configured to:
obtain a target neural network input; and
process the target neural network input using the target neural network, and in accordance with determined values of weights of the target neural network, to generate a target neural network output that performs the processing task;
wherein the values of the weights of the target neural network have been determined by:
receiving task description text that defines a processing task that the target neural network should perform; and
processing a representation of the task description text, using a language model neural network, to generate task encoding data that encodes the processing task; and
generating a frame of data representing the values of the weights of the target neural network by iteratively refining the frame of data, the iterative refining comprising, at each of a succession of weight generation time steps:
processing a frame of data for the weight generation time step, step using a denoising neural network conditioned on the task encoding data, to refine the frame of data for a next weight generation time step, until a final iteration at which the frame of data represents the values of the weights for the target neural network used to perform the processing task.
